(19) United States
(12) Patent Application Publication
(10) Pub. No.: US 2026/0201222 A1
(43) Pub. Date: Jul. 16, 2026

(54) COOLING PLATE ASSEMBLY AND TWO-PART CURABLE ADHESIVE COMPOSITION

(71) Applicant: 3M INNOVATIVE PROPERTIES COMPANY, St. Paul, MN (US)

(72) Inventors: Lianzhou Chen, Woodbury, MN (US); Yaoyao Chen, Fremont, CA (US); Jason V. Ames, Oakdale, MN (US); Surender Maddela, Woodbury, MN (US); Tobias Pick, Korschenbroich (DE); Masayuki Tachi, Sagamihara, Kanagawa (JP)

(21) Appl. No.: 19/137,139

(22) PCT Filed: Dec. 15, 2023
(86) PCT No.: PCT/IB2023/062778

§ 371 Date: Jun. 9, 2025

Related U.S. Application Data
(60) Provisional application No. 63/387,847, filed on Dec. 16, 2022.

(51) Int. Cl. C09J 163/00; C09J 11/08; F28F 3/12

(52) U.S. Cl. CPC C09J 163/00; C09J 11/08; F28F 3/12; F28F 2275/025

(57) ABSTRACT

The present disclosure is directed to a cooling plate assembly useful, for example, to cool batteries for hybrid/electric or electric vehicles. The present disclosure is also directed to two-part curable compositions with improved toughness and improved coolant resistance that may used to adhere, for example, cooling plates for a cooling plate assembly.

The present disclosure is directed to a cooling plate assembly useful, for example, to cool batteries for hybrid/electric or electric vehicles. The present disclosure is also directed to two-part curable compositions with improved toughness and improved coolant resistance that may be used to adhere, for example, cooling plates for a cooling plate assembly.

### BACKGROUND

Batteries are used as power sources for electric vehicles. During the operation or charging of a vehicle battery, the battery heats up. As a result of the heating, the vehicle battery can age prematurely or be damaged due to heat-promoted chemical reactions. It is, therefore, common practice to provide cooling in order to keep the vehicle battery at an optimal operating temperature. Cooling plate assemblies (or simply cooling plates) through which fluid can flow have proven to be a suitable means for cooling items such as, for example, a vehicle battery.

Usually, individual components of cooling plate assemblies are joined together by, for example, welding, soldering, or brazing. At least one cooling channel having an inlet and an outlet is usually contained between the individual components of the cooling plate assemblies. Often, portions of fluid conduits are molded into the individual components of the cooling plate by mechanical shaping processes such that when they are assembled with the other components a fluid conduit is formed by joining the components.

### SUMMARY

In some embodiments, a two-part adhesive composition comprises a curative part (part A) and an epoxy part (part B). In some embodiments, the curative part comprises i) a liquid bis-phenol compound, for example diallyl bisphenol A (DABPA) and ii) a cycloaliphatic amine. The epoxy part comprises i) two or more epoxy resins comprising at least one liquid epoxy resin and at least one multifunctional epoxy resin and ii) core-shell rubber particles, wherein the multifunctional epoxy resin has a functionality of at least 3; wherein the liquid epoxy resin is different from the multifunctional epoxy resin; wherein the cured reaction product of part A and part B has an initial Tg before exposure to coolant and a final Tg after exposure to coolant for two weeks, and wherein the difference between the initial Tg and the final Tg is less than 30° C. under the Coolant Immersion Aging Test described below in the Examples section.

In other embodiments, the epoxy part also comprises core-shell rubber particles.

Additional embodiments of the two-part adhesive of the present disclosure are described below under “Selected Embodiments.”

In another aspect, the present disclosure provides a cured material that results from mixing the curative part with the epoxy part of any of the two-part adhesives according to the present disclosure and allowed to cure. Additional embodiments of the cured material of the present disclosure are described below under “Selected Embodiments.”

In this application:

“Cured reaction product” means the cured material that results from mixing a curative part with an epoxy part and is allowed to cure.

“Epoxy curative” means a compound, oligomer or polymer capable of reacting with an epoxy resin to form crosslinks.

“Epoxy resin” means a compound, oligomer or polymer having reactive epoxide functional groups.

“Epoxy equivalent weight” of an epoxy resin means the weight of resin per epoxide functional group.

“Functionality” of an epoxy resin means the number of epoxide functional groups per molecule.

“Glass transition temperature” (“Tg”) means the temperature at which the glass transition occurs and is determined according to ASTM method E1640-13 as described in the Examples section below. A difference of less than 30° C. when comparing two Tgs means that the difference is less than 30° C.±5° C.

“Liquid epoxy resin” means an epoxy resin which in its uncured state is a liquid under standard temperature (25° C.) and pressure (1 atm).

Overlap Shear Strength (OLS) is the shear strength of an adhesive for bonding to a substrate as determined according to ASTM method D-1002 as described in the Examples section below.

“Solid epoxy resin” means an epoxy resin which in its uncured state is a solid under standard temperature and pressure.

Various embodiments of the present disclosure provide various advantages, some of which are unexpected. For example, according to some embodiments, the cured adhesive having the combination of components described in this disclosure has excellent resistance to coolant, which flows in between the cooling plates, while maintaining excellent metal/metal or plastic/metal bonding performance and low electric conductivity, as described below in the Example section.

### BRIEF DESCRIPTION OF THE DRAWINGS

FIG. 1 is an exploded perspective view of exemplary cooling plate assembly 100 according to the present disclosure.

It should be understood that numerous other modifications and embodiments can be devised by those skilled in the art, which fall within the scope and spirit of the principles of the disclosure. The FIGURES may not be drawn to scale.

### DETAILED DESCRIPTION

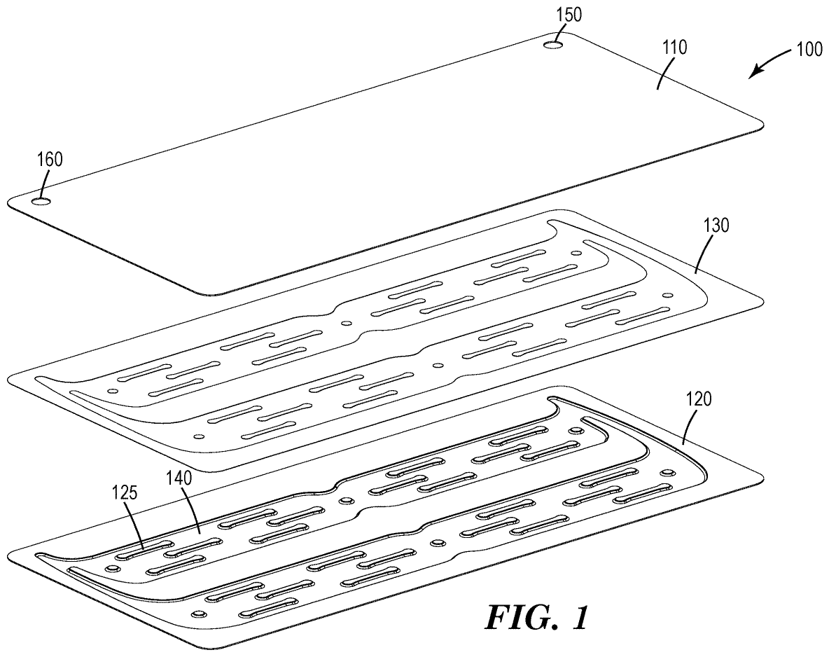

Briefly, the present disclosure provides a cooling plate assembly and an associated two-part adhesive composition that can be used, among other applications, to bond the plates that form part of the assembly. In some embodiments, such as the one described in FIG. 1, cooling plate assemblies comprise two plates bonded together and having channels to carry coolant, which serves to reduce the temperature of battery modules. The two-part adhesive compositions of this disclosure can be used to bond both those two plates.

In some embodiments, a two-part adhesive composition comprises:
A) a curative part comprising:
   i) a liquid bis-phenol compound, such as diallyl bisphenol A (DABPA)
   ii) a cycloaliphatic amine; and
B) an epoxy part comprising:
   i) two or more epoxy resins comprising at least one liquid epoxy resin and at least one multifunctional epoxy resin,
      wherein the multifunctional epoxy resin has a functionality of at least 3; and
      wherein the liquid epoxy resin is different from the multifunctional epoxy resin;
   ii) core-shell rubber particles,
      wherein the cured reaction product of part A and part B has an initial Tg before exposure to coolant and a final Tg after exposure to coolant for 2 weeks, and
      wherein the difference between the initial Tg and the final Tg is less than 30° C. under the Coolant Immersion Aging Test.

In other embodiments, a two-part adhesive composition comprises:
A) a curative part comprising:
   i) liquid bis-phenol compound, such as DABPA,
   ii) a cycloaliphatic amine;
B) an epoxy part comprising:
   i) two or more epoxy resins comprising at least one liquid epoxy resin and at least one multifunctional epoxy resin, wherein the multifunctional epoxy resin has a functionality of at least 3;
   ii) core-shell rubber particles,
   iii) epoxy silane coupling agent,
      wherein the cured reaction product of part A and part B has an initial Tg before exposure to coolant and a final Tg after exposure to coolant for 2 weeks, and
      wherein the difference between the initial Tg and the final Tg is less than 30° C. under the Coolant Immersion Aging Test;
      wherein the cured reaction product of part A and part B has an initial Overlap Shear Strength (OLS) before exposure to coolant and a final Overlap Shear Strength after exposure to coolant under the conditions of the Coolant Immersion Aging Test for 12 weeks, and
      wherein the OLS after exposure to coolant is at least 70% of the initial OLS.

### Curable Adhesive Composition

Two-part adhesive curable compositions of the present disclosure include various two parts: a curative part (part A) and an epoxy part (part B). Non-limiting examples of various components of both parts of the composition are described below.

### Epoxy Part

### Multifunctional Epoxy Resins

In some embodiments, the epoxy part comprises a tris-(hydroxyl phenyl) methane-based epoxy resin, a hydrophobic epoxy resin that imparts good coolant resistance. In some embodiments, the amount of a tris-(hydroxyl phenyl) methane-based epoxy resin is 15 to 40 weight percent (e.g., 15 to 35 weight percent or 20 to 30 weight percent) based on the total weight of the epoxy part.

In some embodiments, the epoxy part comprises a tris-(hydroxyl phenyl) methane-based resin is represented by the formula

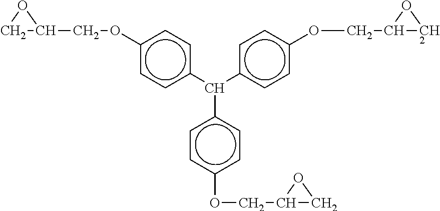

One such material is available as TACTIX 742 from Huntsman Advanced Chemicals, The Woodlands, Texas.

In some embodiments, the epoxy part includes 0.1 to 20 weight percent (e.g., 1 to 15 weight percent or 3 to 8 weight percent), based on the total weight of the epoxy part, of epoxy-functional bisphenol A novolac resin. Often, the epoxy-functional bisphenol A novolac resin has an average epoxy functionality of 3 to 10). Mixtures of epoxy-functional bisphenol A novolac resins may be used. Epoxy-functional bisphenol A novolac resins are commercially available, for example, as, EPON SU-2.5 and EPON SU-8 from Hexion Specialty Chemicals, Columbus, Ohio.

In some embodiments, the epoxy part includes an amount of 5 to 70 weight percent (e.g., 5 to 50 weight percent or 10 to 45 weight percent) of at least one aromatic glycidyl ether having a functional of 3 or higher, based on the total weight of the epoxy part. Exemplary suitable epoxy resins having a functionality of 3 or higher include glycidoxy amines and aminophenols, particularly N,N,N′,N′-tetrakis(glycidyl)-4,4-diaminodiphenyl methane and N,N,O-tris(glycidyl)-4-aminophenol.

### Liquid Epoxy Resin

The liquid epoxy resin component can be in a range of from about 50 weight percent to about 100 weight percent of the epoxy resin part, about 50 weight percent to about 90 weight percent, or less than, equal to, or greater than about 50, 55, 60, 65, 70, 75, 80, 85, or about 95 weight percent of the epoxy resin part. The exact weight percent of the liquid epoxy resin component can be specifically chosen in order to affect the handling of the uncured film. (e.g., the ability to manipulate and apply the composition to a substrate). Moreover, the weight percent of the liquid epoxy resin component can affect the properties of the curable composition or a cured product of the composition. For example, if the curable composition includes a lower weight percent of liquid epoxy resin, the uncured composition might have a relatively high viscosity, which could cause problems when the product is being dispensed. In other instances, a final cured product may have a lower glass transition temperature or be less malleable under certain circumstances. The weight percent of the liquid epoxy resin can also be selected to better match the stoichiometry with the liquid epoxy resin and other components such as a curable resin filler component or curative component so as to not have an excess or too little of any component.

The liquid epoxy resin component can include one or more epoxy resins. The epoxy resins can be the same epoxy resin or can be different epoxy resins. As generally understood, epoxy resins are low molecular weight pre-polymers or higher molecular weight polymers, which can include at least two epoxide groups. In some examples, epoxide groups are also referred to as a glycidyl or oxirane group. Epoxy resins can be polymeric or semi-polymeric materials, and as such variable chain lengths can result from the polymerization reactions used to produce them.

The liquid epoxy resins are chosen from epoxy resins that are a liquid at standard temperature (e.g., 25° C.) and standard pressure (101 kPa). Suitable classes of epoxy resins include monofunctional epoxy resins and multifunctional epoxy resins. Suitable examples of epoxy resins can include one or more epoxy resins that are chosen from a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-Tetraglycidyl-4,4′-methylenebisbenzenamine a triglycidyl of para-aminophenol, N,N,N′,N′-tetraglycidyl-m-xylenediamine or a mixture thereof.

The liquid epoxy resins can be homogenously dispersed in the liquid epoxy resin component, which can be at least in part due to the liquid epoxy resins being liquid at room temperature. In some examples the liquid epoxy can be a mixture of any of the liquid epoxies described herein with a solid epoxy capable of being dissolved, or pre-dissolved, and capable of being a liquid epoxy at about 25° C. In some examples, the solid epoxy can be heated to a temperature ranging from about 50° C. to about 150° C. to make it quicker to dissolve the solid epoxy. After the heating the solution is allowed to cool to a lower temperature such as 25° C.

### Core Shell Rubber Particles

In some embodiments, the epoxy part and/or the curative part include 5 to 20 weight percent or 7 to 19 weight percent of core shell rubber (CSR) particles based on the total weight of the curable composition. CSR particles may have a core selected from the group consisting of methyl methacrylate-butadiene-styrene (MBS) copolymers, methyl methacrylate-acrylonitrile-butadiene-styrene (MABS) copolymers or a combination thereof. CSR particles may also have a shell formed from an acrylic polymer, an acrylic copolymer, or a combination thereof. They are commercially available from suppliers such as, for example, Kaneka Texas Corporation, and Kukdo Chemical, Seoul, South Korea.

In other embodiments, the core-shell rubber particles may be a combination of silicone CSR particles and MBS CSR particles.

In some embodiments, curable compositions include 0 to 20 weight percent (e.g., 2 to 12 weight percent or 4 to 10 weight percent), based on the total weight of the curative or epoxy part, as the case may be, of core-shell toughening agents. Examples include CLEARSTRENGTH XT100 from Arkema S.A. Colombes, France.

In practice of the present disclosure, at least one epoxy resin may be chosen to be free of ester, and/or urethane groups, or other hydrolyzable chemical bonds which can be hydrolyzed by water or alcoholyzed by alcohol and which may then lead to degradation of adhesive properties.

### Epoxy Silane Coupling Agent

In some embodiments, the epoxy part includes 0.1 to 15 weight percent of epoxy-functional hydrolyzable organosilane based on the total weight of the epoxy part, although other amounts may be used. In other embodiments, the epoxy part comprises from 0.1% to 10%, 0.1% to 5%, 0.1% to 3%, 1% to 10%, 1% to 5%, 1% to 3% weight percent based on the total weight of the epoxy resin part.

Useful epoxy-functional hydrolyzable organosilanes contain at least one hydrolyzable silyl group and at least one epoxy group. Examples of hydrolyzable silyl groups (e.g., —SiX₃) include those having a silicon atom bonded to at least one group selected from alkoxy (e.g., methoxy or ethoxy), acyloxy (e.g., acetoxy), halogen (e.g., Cl, Br), and combinations thereof. Often the hydrolyzable group is a trimethoxysilyl group or a triethoxysilyl group.

Exemplary epoxy-functional hydrolyzable organosilane compounds include those represented by the formula

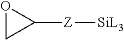

and wherein Z is a divalent organic group, and each L is independently a hydrolyzable group. Often Z contains one or more catenary oxygen atoms. In some embodiments, Z represents a hydrocarbyl group; for example, a hydrocarbyl group having from 2 to 36 carbon atoms, preferably 2 to 12 carbon atoms, and more preferably 2-4 carbon atoms. In some embodiments, Z represents a divalent group having the formula —CH₂OR¹— wherein R¹ represents a divalent organic group; for example, a divalent hydrocarbylene group having 2 to 12 carbon atoms, preferably 2-4 carbon atoms.

In some embodiments, the epoxy-functional hydrolyzable organosilane is represented by the formula

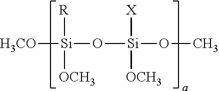

wherein R and X are each independently epoxy-based moieties and a is an integer greater than or equal to 1. One exemplary such material is available commercially as DYNASYLAN VPS 4721 from Evonik Industries AG, Essen, Germany or DOWIL Z-6040 from Dow Chemical Company, Midland, MI. In some embodiments, 1 to 10 weight percent of such compounds are included in the adhesive.

Examples of suitable epoxy-functional hydrolyzable organosilane compounds also include 3-glycidoxypropyltrimethoxysilane, 3-glycidoxypropyltriethoxysilane, 2-(3,4-epoxycyclohexyl)-ethyltriethoxysilane; 2-(3,4-epoxycyclohexyl)ethyltrimethoxysilane; 5,6-epoxyhexyltriethoxysilane; 8-glycidoxyoctyltrimethoxysilane; (3-glycidoxypropyl)methyldiethoxysilane; (3-glycidoxypropyl)-methyldimethoxysilane; 2-(3,4-epoxycyclohexyl)ethylmethyldiethoxysilane; (3-glycidoxypropyl)-dimethylethoxysilane; and 1-(3-glycidoxypropyl)-1,1,3,3,3-pentaethoxy-1,3-disilapropane. In some embodiments, 1 to 10 weight percent of such compounds are included in the adhesive.

Combinations of epoxy-functional hydrolyzable organosilane compounds may be, and often are used.

### Curative Part

The curative part can be in a range of from about 5 weight percent to about 80 weight percent of the sum of the weight of the epoxy and curative parts, about 15 weight percent to about 55 weight percent, or less than, equal to, or greater than about 5 weight percent, 10, 15, 20, 25, 30, 35, 40, 45, 50, 55, 60, 65, 70, 75, or about 80 weight percent of the sum of the weight of the epoxy and curative parts.

The curative part comprises at least one liquid bis-phenol compound and at least one cycloaliphatic amine.

### Liquid Bis-Phenol Compound

Bisphenol compounds (BPs) are a group of artificial chemicals containing two phenolic rings or alkyd substituted phenolic rings bridged by a carbon, sulfur group, oxygen, or some longer chains linkage. “Liquid bisphenol” means a bisphenol compound which in its uncured state is a liquid under standard temperature (25° C.) and pressure (1 atm).

In some embodiments, the curative part includes 5% to 60% weight percent of liquid bis-phenol compound in the curative part to facilitate epoxy curing, based on the total weight of the curative part. In other embodiments, the curative part includes 10% to 50%, 10% to 40%, 15% to 50%, and 15% to 40% weight percent of liquid bis-phenol compound based on the total weight of the curative part.

In some preferred embodiments, the liquid bis-phenol compound is diallyl bisphenol A (DABPA).

### Cycloaliphatic Amine

In some embodiments, the curative part includes 10 to 90 weight percent of a cycloaliphatic amine based on the total weight of the curative part. In other embodiments, the cycloaliphatic amine is present in an amount from 10% to 80%, 10% to 70%, 10% to 60%, 20% to 90%, 20% to 80%, 20% to 70%, 20% to 60%, 30% to 90%, 30% to 80%, 30% to 70%, 30% to 60%, weight percent based on the total weight of the curative part.

Examples of suitable cycloaliphatic amines include 4,4′-methylenebis(2-methylcyclohexyl-amine), available under the trade designation ANCAMINE 2049, and the mixture of 4,4-Methylenebiscyclohexanamine, methyleneoxide, polymer with benzenamine, hydrogenated, available under the trade designation ANCAMINE 2167, available from Evonik Industries, Essen, Germany.

In some embodiments, the curative part includes 0.01 to 6 weight percent (e.g., 0.01 to 2 weight percent), based on the total weight of the curative part, of an accelerator to facilitate epoxy curing, although it may be omitted entirely. Examples include K54, available from Evonik Industries, and calcium triflate or calcium nitrate, available from Aldrich.

### Other Components

Additional components and additives may also be included in curable composition according to the present disclosure such as, for example, colorants, antioxidants, thixotropes, fillers such as heat-conductive and/or electrically conductive filler, and beads to control bondline thickness. Exemplary beads includes E-SPHERES SL350 from Envirospheres Pty. Ltd., Lindfield, Australia.

In some embodiments, the curable compositions include 1 to 5 weight percent (e.g., 1 to 3 weight percent), based on the total weight of the curable composition, of surface-modified fumed silica. The surface modification is typically a hydrophobic surface treatment, but other surface treatments are also permissible. Fumed silicas are available commercially for suppliers such as, for example, Evonik Corp., Essen, Germany under the trade designation AEROSIL (e.g., in grades R816, R504, R104, R106, and R709) and from Cabot Corporation, Boston, MA under the trade designation CAB-O-SIL TS-720.

Referring now to FIG. 1, exemplary cooling plate assembly 100 comprises two component plates 110, 120 bonded together by adhesive 130. Component plate 110 is flat on both sides with two holes, inlet 150 and outlet 160. Component plate 120 has features 125 that are raised in comparison to adjacent areas of component plate 120. Adhesive 130 contacts the raised features 125 and the first plate 110 and binds them together to collectively define fluid conduit 140. Adhesive 130 comprises an epoxy adhesive having a liquid bisphenol compound as described previously.

An exemplary method of making a cooling plate assembly comprises to dispense a paste adhesive of a curable composition on to the first plate. Then, a second component plate (e.g., a top plate which may or may not have raised features) and having inlet and outlet openings therethrough is adhered to the first plate having adhesive on it and the entire assembly is heated under pressure to provide a cooling plate assembly according to the present disclosure, whereby the curable composition is sufficiently cured to form the cooling plates. Through this process the adhesive and the component plates collectively define at least one fluid conduit having an inlet and an outlet, and wherein the adhesive comprises an epoxy adhesive having a liquid bisphenol compound.

Cooling plate assemblies according to the present disclosure are useful, for example, for cooling batteries by placing them adjacent to (e.g., between) battery cells often found in hybrid or full electric vehicles.

Objects and advantages of this disclosure are further illustrated by the following non-limiting examples, but the particular materials and amounts thereof recited in these examples, as well as other conditions and details, should not be construed to unduly limit this disclosure.

### EXEMPLARY EMBODIMENTS

1. A two-part adhesive composition comprising:
   A) a curative part comprising:
      i) a liquid bis-phenol compound
      ii) a cycloaliphatic amine;
   B) an epoxy part comprising:
      i) two or more epoxy resins comprising at least one liquid epoxy resin and at least one multifunctional epoxy resin,
         wherein the multifunctional epoxy resin has a functionality of at least 3; and
         wherein the liquid epoxy resin is different from the multifunctional epoxy resin;
      ii) core-shell rubber particles,
   wherein the cured reaction product of part A and part B has an initial Tg before exposure to coolant and a final Tg after exposure to coolant for 2 weeks, and
   wherein the difference between the initial Tg and the final Tg is less than 30° C. under the Coolant Immersion Aging Test.
2. A two-part adhesive composition comprising:
   A) a curative part comprising:
      i) diallyl bisphenol A (DABPA);
      ii) a cycloaliphatic amine;
   B) an epoxy part comprising:
      i) two or more epoxy resins comprising at least one liquid epoxy resin and at least one multifunctional epoxy resin,
         wherein the multifunctional epoxy resin has a functionality of at least 3; and
         wherein the liquid epoxy resin is different from the multifunctional epoxy resin;
      ii) core-shell rubber particles,
   wherein the cured reaction product of part A and part B has an initial Tg before exposure to coolant and a final Tg after exposure to coolant for 2 weeks, and
   wherein the difference between the initial Tg and the final Tg is less than 30° C. under the Coolant Immersion Aging Test.
3. A two-part adhesive composition comprising:
   A) a curative part comprising:
      i) liquid bis-phenol compound,
      ii) a cycloaliphatic amine;
   B) an epoxy part comprising:
      i) two or more epoxy resins comprising at least one liquid epoxy resin and at least one multifunctional epoxy resin, wherein the multifunctional epoxy resin has a functionality of at least 3;
      ii) core-shell rubber particles,
      iii) epoxy silane coupling agent,
   wherein the cured reaction product of part A and part B has an initial Tg before exposure to coolant and a final Tg after exposure to coolant for 2 weeks, and
   wherein the difference between the initial Tg and the final Tg is less than 30° C. under the Coolant Immersion Aging Test;
   wherein the cured reaction product of part A and part B has an initial Overlap Shear Strength (OLS) before exposure to coolant and a final Overlap Shear Strength after exposure to coolant under the conditions of the Coolant Immersion Aging Test for 12 weeks, and
   wherein the OLS after exposure to coolant is at least 70% of the initial OLS.
4. A two-part adhesive composition comprising:
   A) a curative part comprising:
      i) DABPA,
      ii) a cycloaliphatic amine;
   B) an epoxy part comprising:
      i) two or more epoxy resins comprising at least one liquid epoxy resin and at least one multifunctional epoxy resin, wherein the multifunctional epoxy resin has a functionality of at least 3;
      ii) core-shell rubber particles,
      iii) epoxy silane coupling agent,
   wherein the cured reaction product of part A and part B has an initial Tg before exposure to coolant and a final Tg after exposure to coolant for 2 weeks, and
   wherein the difference between the initial Tg and the final Tg is less than 30° C. under the Coolant Immersion Aging Test;
   wherein the cured reaction product of part A and part B has an initial Overlap Shear Strength (OLS) before exposure to coolant and a final Overlap Shear Strength after exposure to coolant under the conditions of the Coolant Immersion Aging Test for 12 weeks, and
   wherein the OLS after exposure to coolant is at least 70% of the initial OLS.
5. A two-part adhesive composition according to any of the preceding claims further comprising an epoxy silane coupling agent in the epoxy part,
   wherein the cured reaction product of part A and part B has an initial Overlap Shear Strength (OLS) before exposure to coolant and a final Overlap Shear Strength after exposure to coolant under the conditions of the Coolant Immersion Aging Test for 12 weeks, and
   wherein the OLS after exposure to coolant is at least 70% of the initial OLS.
6. A two-part adhesive composition according to any of the preceding claims, wherein the curative part further comprises core-shell rubber particles.
7. A two-part adhesive composition according to any of the preceding claims, wherein the molar ratio of the liquid bis-phenol compound to the cycloaliphatic amine in the curative part ranges from 5 to 60.
8. A two-part adhesive composition according to any of the preceding claims, wherein the molar ratio of the liquid bis-phenol compound to the cycloaliphatic amine in the curative part ranges from 10 to 50.
9. A two-part adhesive composition according to any of the preceding claims, wherein the epoxy part further comprises silicone core-shell rubber particles.
10. A two-part adhesive composition according to any of the preceding claims, comprising the liquid bis-phenol compound in a range from 5% to 60% weight percent based on the total weight of the curative part.
11. A two-part adhesive composition according to any of the preceding claims, comprising the liquid bis-phenol compound in a range from 10% to 50% weight percent based on the total weight of the curative part.
12. A two-part adhesive composition according to any of the preceding claims, wherein the liquid bis-phenol compound is DABPA.
13. A two-part adhesive composition according to any of the preceding claims, wherein the curative part comprises a cycloaliphatic amine in a range from 10% to 90% weight percent based on the total weight of the curative part.
14. A two-part adhesive composition according to any of the preceding claims, wherein the curative part comprises a cycloaliphatic amine in a range from 30% to 90% weight percent based on the total weight of the curative part.
15. A two-part adhesive composition according to any of the preceding claims, wherein the cycloaliphatic amine is chosen from 4,4′-methylenebiscyclohexyl-amine or its alkyl substitutes.
16. A two-part adhesive composition according to any of the preceding claims, wherein the cycloaliphatic amine is 4,4′-methylenebis(2-methylcyclohexyl-amine)
17. A two-part adhesive composition according to any of the preceding claims, wherein the molar ratio of a liquid epoxy resin to multifunctional epoxy resin in the epoxy part ranges from 10 to 70.
18. A two-part adhesive composition according to any of the preceding claims, wherein the molar ratio of the liquid epoxy resin to multifunctional epoxy resin in the epoxy part ranges from 10 to 50.
19. A two-part adhesive composition according to any of the preceding claims, wherein the liquid epoxy resin in the epoxy part is in a range from 50% to 100% weight percent based on the total weight of the epoxy resin part.
20. A two-part adhesive composition according to any of the preceding claims, wherein the liquid epoxy resin in the epoxy part is in a range from 50% to 85% weight percent based on the total weight of the epoxy resin part.
21. A two-part adhesive composition according to any of the preceding claims, wherein the liquid epoxy resin is chosen from diglycidyl ethers of bisphenol F, low epoxy equivalent weight diglycidyl ethers of bisphenol A, liquid epoxy novolac resins, liquid aliphatic epoxy resins, liquid cycloaliphatic epoxy resins, 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, triglycidyls of para-aminophenol, N,N,N′,N′-tetraglycidyl-m-xylenediamine, and mixtures thereof.
22. A two-part adhesive composition according to any of the preceding claims, wherein the multifunctional epoxy resin in the epoxy part ranges from 5% to 70% weight percent based on the total weight of the epoxy resin part.
23. A two-part adhesive composition according to any of the preceding claims, wherein the multifunctional epoxy resin in the epoxy part ranges from 5% to 50% weight percent based on the total weight of the epoxy resin part.
24. A two-part adhesive composition according to any of the preceding claims, wherein the multifunctional epoxy resin is chosen from trifunctional glycidyl amine type epoxy resin (araldite MY 0510) trifunctional tris-(hydroxyl phenyl) methane-based epoxy resins (tactix 742), N,N,N′,N′-tetraglycidyl-4,4′-methylenebisbenzenamine (araldite MY 721)
25. A two-part adhesive composition according to any of the preceding claims, comprising an amount of core-shell rubber particles in the epoxy part that ranges from 5% to 40% weight percent based on the total weight of the epoxy resin part.
26. A two-part adhesive composition according to any of the preceding claims, comprising an amount of core-shell rubber particles in the epoxy part that ranges from 10% to 30% weight percent based on the total weight of the epoxy resin part.
27. A two-part adhesive composition according to any of the preceding claims, comprising an amount of core-shell rubber particles in the curative part a range from 1% to 15% weight percent based on the total weight of the curative part.
28. A two-part adhesive composition according to any of the preceding claims, comprising an amount of core-shell rubber particles in the curative part a range from 3% to 10% weight percent based on the total weight of the curative part.
29. A two-part adhesive composition according to any of the preceding claims, wherein the core-shell rubber particles have a core chosen from methyl methacrylate-butadiene-styrene (MBS) copolymers, methyl methacrylate-acrylonitrile-butadiene-styrene (MABS) copolymers, and combination thereof.
30. A two-part adhesive composition according to any of the preceding claims, wherein the core-shell rubber particles have a shell chosen from acrylic polymers, acrylic copolymers, and combinations thereof.
31. A two-part adhesive composition according to any of the preceding claims, comprising the epoxy silane coupling agent in a range from 0.1% to 5% weight percent based on the total weight of the epoxy resin part.
32. A two-part adhesive composition according to any of the preceding claims, comprising the epoxy silane coupling agent in a range from 1% to 3% weight percent based on the total weight of the epoxy resin part.
33. A two-part adhesive composition according to any of the preceding claims, wherein the epoxy silane coupling agent is chosen from compounds represented by the formula

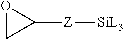

and wherein Z is a divalent organic group, and each L is independently a hydrolyzable group.
34. A two-part adhesive composition according to any of the preceding claims, wherein the epoxy silane coupling agent is chosen from compounds represented by the formula

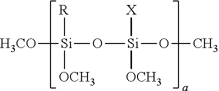

wherein R and X are each independently epoxy-based moieties and a is an integer greater than or equal to 1.
35. A two-part adhesive composition according to any of the preceding claims, wherein the epoxy silane coupling agent is chosen from 3glycidoxypropyltrimethoxysilane, 3-glycidoxypropyltriethoxysilane, 2-(3,4-epoxycyclohexyl)-ethyltriethoxysilane; 2(3,4epoxycyclohexyl)ethyltrimethoxysilane; 5,6-epoxyhexyltriethoxysilane; 8-glycidoxyoctyltrimethoxysilane; (3-glycidoxypropyl)-methyldiethoxysilane; (3-glycidoxypropyl)¬methyldimethoxysilane; 2-(3,4-epoxycyclohexyl)-ethylmethyldiethoxysilane; (3-glycidoxypropyl)¬dimethylethoxysilane; and 1-(3-glycidoxypropyl)-1,1,3,3,3-pentaethoxy-1,3-disilapropane, and mixtures thereof.
36. A two-part adhesive composition according to any of the preceding claims, wherein the OLS after exposure to coolant is at least 80% of the initial OLS.
37. A two-part adhesive composition according to any of the preceding claims, wherein the OLS after exposure to coolant is at least 90% of the initial OLS
38. A two-part adhesive composition according to any of the preceding claims, wherein the OLS after exposure to coolant is at least 95% of the initial OLS.
39. A two-part adhesive composition according to any of the preceding claims, wherein exposure to coolant under the conditions of the Coolant Immersion Aging Test for 18 weeks, and wherein the OLS after exposure to coolant is at least 70% of the initial OLS.
40. A two-part adhesive composition according to any of the preceding claims, wherein exposure to coolant under the conditions of the Coolant Immersion Aging Test for 18 weeks, and wherein the OLS after exposure to coolant is at least 80% of the initial OLS.
41. A two-part adhesive composition according to any of the preceding claims, wherein exposure to coolant under the conditions of the Coolant Immersion Aging Test for 18 weeks, and wherein the OLS after exposure to coolant is at least 90% of the initial OLS.
42. A two-part adhesive composition according to any of the preceding claims, wherein exposure to coolant under the conditions of the Coolant Immersion Aging Test for 18 weeks, and wherein the OLS after exposure to coolant is at least 95% of the initial OLS.
43. A two-part adhesive composition according to any of the preceding claims, wherein the exposure to coolant is for 4 weeks, and wherein the difference between the initial Tg and the final Tg is less than 30° C. under the Coolant Immersion Aging Test.
44. A two-part adhesive composition according to any of the preceding claims, wherein the exposure to coolant is for 6 weeks, and wherein the difference between the initial Tg and the final Tg is less than 30° C. under the Coolant Immersion Aging Test.
45. A two-part adhesive composition according to any of the preceding claims, wherein the exposure to coolant is for 10 weeks, and wherein the difference between the initial Tg and the final Tg is less than 30° C. under the Coolant Immersion Aging Test.
46. A two-part adhesive composition according to any of the preceding claims, wherein the exposure to coolant is for 15 weeks, and wherein the difference between the initial Tg and the final Tg is less than 30° C. under the Coolant Immersion Aging Test.
47. A two-part adhesive composition according to any of the preceding claims, wherein the exposure to coolant is for 28 weeks, and wherein the difference between the initial Tg and the final Tg is less than 30° C. under the Coolant Immersion Aging Test.
48. A cooling plate assembly comprising the cured reaction product of part A and part B described in any of the preceding claims.

### EXAMPLES

Unless otherwise noted, all parts, percentages, ratios, etc. in the Examples and the rest of the specification are by weight. Table 1 (below) reports abbreviations and descriptions of material used in the examples. Trademarks and trade names are displayed in all caps.

TABLE 1
Materials List

| Material | Description | Source |
|---|---|---|
| E1001F | A low molecular weight solid epoxy derived from liquid | Hexion Chemical |
| | epoxy resin and bisphenol-A, available under the trade | Company, Columbus, |
| | designation EPON Resin 1001F | OH, United States |
| E828 | Difunctional bisphenol-A/epichlorohydrin derived liquid | Hexion Chemical |
| | epoxy resin, available, under the trade designation EPON | Company |
| | Resin 828 | |
| MY510 | A trifunctional glycidyl amine type epoxy resin, available | Huntsman Corporation, |
| | under the trade designation ARALDITE MY 0510 | The Woodlands, TX, |
| | | United States |
| MY721 | A N,N,N′,N′-tetraglycidyl-4,4′-methylenebisbenzenamine | Huntsman Corporation |
| | based epoxy resin, available under the trade designation | |
| | ARALDITE MY 721 | |
| MX962 | 25 ± 1% silicone core shell rubber in bisphenol-A liquid | Kaneka Corporation, |
| | epoxy, available under the trade designation KANE ACE | Osaka-shi, Japan |
| | MX 962 | |
| MX257 | 37 ± 1% methacrylate-butadiene-styrene (MBS) core shell | Kaneka Corporation |
| | rubber in bisphenol-A liquid epoxy, available under the | |
| | trade designation KANE ACE MX 257 | |
| MK107 | Cyclohexane dimethanol diglycidyl ether, available under | Hexion Chemical |
| | the trade designation HEROXY MK-107 | Company |
| XT100 | Methylmethacrylate-butadiene-styrene (MBS) core-shell | Arkema S.A., |
| | toughening agent, available under the trade designation | Colombes, France |
| | CLEARSTRENGTH XT100 | |
| T742 | A tri-functional tris-(hydroxyl phenyl) methane-based epoxy | Huntsman Corporation |
| | resin, available under the trade designation TACTIX 742 | |
| Z6040 | A bifunctional silane containing a glycidoxy reactive | Dow Chemical |
| | organic group and a trimethoxysilyl inorganic group, | Company, Midland, MI, |
| | available under the trade designation DOWSIL Z-6040 | United States |
| SL350 | White hollow ceramic microspheres, available under the | Envirospheres Pty. Ltd., |
| | trade designation E-SPHERES SL350 | Lindfield, Australia |
| TS720 | Fumed silica, available under the trade designation | Cabot Corporation, |
| | CAB-O-SIL ® TS-720 | Boston, MA, United |
| | | States |
| A2049 | 4,4′-methylenebis(2-methylcyclohexyl-amine), epoxy | Evonik Industries, |
| | curative, available under the trade designation ANCAMINE | Essen, Germany |
| | 2049 | |
| A2482 | A modified polyamide curing agent, available under the | Evonik Industries |
| | trade designation ANCAMINE 2482 | |
| A2167 | A cycloaliphatic amine curing agent, available under the | Evonik Industries |
| | trade designation ANCAMINE 2167 | |
| THF 100 | Polyetheramine, available under the trade designation | Huntsman Corporation |
| | JEFFAMINE THF-100 | |
| TTD | 4,7,10-Trioxa-1,13-tridecanediamine | BASF |
| MX660 | 25% silicone core shell rubber in diallyl bisphenol-A liquid | Kaneka Corporation |
| | epoxy, available under the trade designation KANE ACE | |
| | MX 660 | |
| TM124 | 2,2′-Bis (3-allyl-4-hydroxyphenyl)propane, available under | Evonik Industries |
| | the trade designation COMPIMIDE TM124 | |
| K54 | A curing agent based on tris-(dimethylaminomethyl) phenol, | Evonik Industries |
| | available under the trade designation ANCAMINE K54 | |
| AC 130-2 | Sol-gel based primer, available under the trade designation | 3M, St. Paul, MN. |
| | 3M Surface Pre-Treatment AC-130-2 | United States |

### Test Methods

Grade 2024T3 bare aluminum panels were obtained from Erickson Metals of Minnesota, Inc., Coon Rapids, Minn. Prior to bonding with structural adhesive, the panels were subjected to one of the following surface preparation processes:

### Panel Preparation

### Scotch Brit Cloth Abrasion/Sol-Gel Primed Panels

The bare aluminum panels were slightly abraded with a 3M SCOTCHBRITE (obtained from 3M Company) to remove the surface oxide layer for about 10-30 seconds. Residual dust was removed by means of compressed air, rinsing with solvent and allowing to dry for 10 minutes at approximately 25° C. The aluminum panel was then pre-treated with AC-130-2 and dried at 75° F. (23.9° C.) for 60 minutes according to AC-130-2 standard preparation method, after which a sample was applied, and cured at 250° F. (121° C.) for 30 minutes.

After the samples were applied onto the end of the primed aluminum panel (measuring 4 inches×1 inches×0.063 inches (10.16 cm×2.54 cm×0.16 cm)), a second equally sized abraded and primed aluminum panel was then applied over the sample at an overlap of 0.5 inches (12.7 mm). The assembly was clamped together using metal clamps and cured as described above.

### Overlap Shear Strength (OLS) Test

Overlap shear strength was measured according to ASTM D-1002, by means of a model “SINTECH-30” tensile tester, obtained from MTS Corporation, Eden Prairie, Minnesota, at a grip separation rate of 0.05 inches/minute (1.3 mm/min). Three test panels were prepared and evaluated per each example and the average value is reported.

### Floating Roller Peel (FRP) Strength Test

Two primed and etched aluminum panels, one measuring 63 mils by 8-inches by 1-inches (1.60 mm by 20.32 cm by 2.54 cm), the other measuring 25 mils by 10-inches by 3-inches (0.635 mm by 25.4 cm by 2.54 cm), were bonded together as described in the Overlap Shear Strength Test. Test strips, from the bonded panel assembly were evaluated for floating roller peel strength of the thinner substrate, according to ASTM D-3167-76, using a tensile strength tester, model “SINTECH 20” from MTS Corporation, at a separation rate of 6 inches/minute (15.24 cm/min) and at 70° F. (21.1° C.). Three test panels were prepared and evaluated per each example.

### Coolant Immersion Aging (CIA) Test

A set of the testing OLS specimens were made according to OLS standard procedure stated above. After they were made, they were placed into DEX-COOL 50/50 coolant (obtained from PRESTONE® of Lake Forest, IL. United States) at 90° C. for aging. After two, four, six, nine, and/or twelve weeks, the sample was removed and OLS testing was performed.

### Glass Transition Temperature (GTT) Test

Glass transition temperature (Tg) was determined by DMA and according to ASTM E1640-13. Samples approximately 1-2 mm thick, 6-10 mm wide and 20 mm long were machined from a larger sample of cured epoxy. Sample thickness and width were measured at three points along the specimen length using a micrometer, and the average of these measurements was used for calculation of cross-sectional area. Length of samples were measured by TA Instruments Q800 DMA. DMA testing was performed using a TA Instruments Q800 DMA. The T_{g} was used by the onset T_{g} of the storage modulus, according to ASTM D7028-07.

### Examples 1-7 (EX1-7) and Comparative Examples 1 & 2 (CE1 & CE2)

Quantities (in weight percent) of E1001F, E828, MY510, MY721, MX962, MK107 and T742 as identified in Table 2 for Part B Compositions, were added to a plastic cup and mixed by means of a high-speed mixer operating at 2,200 RPM at ambient temperature (i.e., 21° C.) for 3-5 minutes until the resin was dissolved. XT100 was added and mixed at 2,200 RPM again for 5-10 minutes until the XT100 dispersed. Z6040 and TS720 were added, and speed mixed at 2,200 RPM for 2-4 minutes. SL350 was then added, and speed mixed to uniformly mix with the other materials.

TABLE 2
Part B Compositions (in weight percent (wt. %))

| | CE1 | CE2 | EX1 | EX2 | EX3 | EX4 | EX5 | EX6 | EX7 |
|---|---|---|---|---|---|---|---|---|---|
| E1001F | | | 0.0 | 0.0 | 3.3 | 0.0 | 0.0 | 0.0 | 0.0 |
| E828 | 25.6 | 26.1 | 0.0 | 0.0 | 0.0 | 26.0 | 20.7 | 23.3 | 23.5 |
| MY510 | | | 0.0 | 0.0 | 30.0 | 0.0 | 0.0 | 0.0 | 0.0 |
| MY721 | 32.1 | 32.7 | 32.7 | 31.3 | 0.0 | 0.0 | 0.0 | 0.0 | 0.0 |
| MX962 | | | 0.0 | 0.0 | 0.0 | 0.0 | 8.0 | 0.0 | 6.7 |
| MX 257 | | | 39.2 | 42.6 | 41.7 | 53.3 | 52.3 | 57.7 | 49.2 |
| MK107 | 6.4 | 6.5 | 6.5 | 6.3 | 6.0 | 6.0 | 6.0 | 6.0 | 6.0 |
| XT100 | 20.2 | 20.6 | 6.2 | 4.4 | 4.3 | 0.0 | 0.0 | 0.0 | 0.0 |
| T742 | 9.6 | 9.8 | 9.8 | 9.4 | 9.3 | 9.3 | 9.3 | 9.3 | 9.3 |
| Z6040 | 1.9 | | 2.0 | 1.9 | 1.7 | 1.7 | 1.7 | 1.7 | 1.7 |
| SL350 | 1.9 | 2.0 | 2.0 | 1.9 | 1.7 | 1.7 | 0.0 | 0.0 | 1.7 |
| TS720 | 2.2 | 2.3 | 1.6 | 2.2 | 2 | 2 | 2 | 2 | 2 |

Typical procedure: Quantities (in weight percent) A2049, A2482, TTD and A2167 for Part A Compositions were added to a plastic cup and mixed well. Then XT100 was added, by means of a high-speed mixer operating at 2,200 RPM at ambient temperature (i.e., 21° C.) for 5-10 minutes until the XT100 dispersed well. MX660, TM124, THF100 and K54 were added and mixed well. Then TS720 was added, and the mixture was speed mixed at 2,200 RPM again for 2-4 minutes. SL350 was added and speed mixed to uniformly mix with the other materials.

While for CE2, a amine/EPON 828 adduct was conducted first for TTD and EDR with EPON 828. First, we mix TTD and EDR 148 well, then add EPON 828. Under agitation, we allow the reaction of epoxy and excessive amine to react together. Control the reaction temperature between 70-100° C. for the reaction to finish. After 60-90 min, add other ingredients following the typical procedure described above to make part A curatives for CE2.

TABLE 3
Part A Compositions (in weight percent (wt. %))

| | CE1 | CE2 | EX1 | EX2 | EX3 | EX4 | EX5 | EX6 | EX7 |
|---|---|---|---|---|---|---|---|---|---|
| TTD | 25.6 | 27.5 | | | | | | | |
| EDR 148 | | 24.2 | | | | | | | |
| EPON 828 | | 11.8 | | | | | | | |
| A2049 | | | 0.0 | 0.0 | 32.9 | 32.9 | 32.9 | 32.9 | 32.9 |
| A2482 | 26.9 | | 42.9 | 26.7 | 0.0 | 0.0 | 0.0 | 0.0 | 0.0 |
| A2167 | 19.2 | | 40.9 | 25.3 | 39.5 | 39.5 | 39.5 | 39.5 | 39.5 |
| MX660 | | | 0.0 | 41.5 | 19.7 | 19.7 | 0.0 | 0.0 | 0.0 |
| THF 100 | 9.6 | | | | | | | | |
| ATBN1300-16 | | 13.1 | | | | | | | |
| TM124 | | | 0.0 | 0.0 | 0.0 | 0.0 | 14.8 | 14.8 | 14.8 |
| XT100 | 11.6 | 16.3 | 8.9 | 0.0 | 0.0 | 0.0 | 0.0 | 0.0 | 4.9 |
| K54 | 2.6 | 2.0 | 2.6 | 2.3 | 2.6 | 2.6 | 2.6 | 2.6 | 2.6 |
| TS720 | 1.9 | 2.7 | 1.3 | 1.8 | 2.6 | 2.6 | 2.6 | 2.6 | 2.6 |
| SL350 | 1.9 | 2.0 | 3.4 | 2.3 | 2.6 | 2.6 | 7.6 | 7.63 | 2.6 |

Part A and Part B Compositions were mixed in a 2:1 ratio for CE1, CE2, and EX1, a 3:2 ratio for EX2, and a 3:1 ratio for EX3-EX7 in a plastic cup and mixed by means of a high-speed mixer operating at 2,200 RPM at ambient temperature (i.e., 21° C.) for 20-40 seconds. The samples underwent OLS and FRP testing, and the results are represented in Table 4. Samples underwent CIA and GTT testing, and the results are represented in Tables 5 and 6.

TABLE 4
OLS and FRP Test Results

| | CE1 | EX1 | EX2 | EX3 | EX4 | EX5 | EX6 | EX7 |
|---|---|---|---|---|---|---|---|---|
| OLS (MPa) | 23.6 | 20.0 | 26.6 | 25.9 | 26.2 | 24.6 | 24.6 | 25.8 |
| FRP (N/mm) | 2.5 | 0.8 | 2.9 | 2.6 | 3.3 | 3.4 | 3.5 | 3.7 |

TABLE 5
CIA Test Results

| | CE1 | EX2 | EX4 | EX5 | EX6 | EX7 |
|---|---|---|---|---|---|---|
| OLS (MPa), initial | 22 | 26.6 | 26.2 | 28.4 | 28.4 | 28.3 |
| OLS (MPa), 6 weeks | 17.4 | 25.3 | 26 | NT | NT | NT |
| OLS (MPa), 12 weeks | NT | 23 | 24.7 | 27.2 | 26.5 | 28.8 |
| OLS (MPa), 18 weeks | 12.3 | 26.5 | 25.3 | 27.3 | 27.8 | 28.9 |

NT—Not Tested

TABLE 6
GTT Test Results

| | CE1 | CE2 | EX1 | EX2 | EX3 | EX4 | EX5 | EX6 | EX7 |
|---|---|---|---|---|---|---|---|---|---|
| Tg, | 109 | 100 | 154 | 130 | 162 | 150 | 148 | 148 | 150 |
| initial, ° C. | | | | | | | | | |
| Tg, ° C. | 94 | 65 | 139 | NA | NA | 140 | 138 | 137 | 138 |
| (weeks) | (1 w) | (1 w) | (2 w) | | | (2 w) | (2 w) | (2 w) | (2 w) |
| Tg, ° C. | NA | NA | 135 | 115 | 138 | 140 | NA | NA | NA |
| (weeks) | | | (4 w) | (4 w) | (4 w) | (4 w) | | | |
| Tg, ° C. | NA | NA | 134 | NA | NA | 138 | 134 | 130 | 135 |
| (weeks) | | | (6 w) | | | (6 w) | (10 w) | (10 w) | (10 w) |
| Tg, ° C. | NA | NA | 128.3 | NA | NA | 134 | 128 | 126 | 130 |
| (weeks) | | | (15 w) | | | (15 w) | (28 w) | (28 w) | (28 w) |

NT—Not Tested

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A two-part adhesive composition comprising:
A) a curative part comprising:
i) a liquid bis-phenol compound
ii) a cycloaliphatic amine;
B) an epoxy part comprising:
i) two or more epoxy resins comprising at least one liquid epoxy resin and at least one multifunctional epoxy resin,
wherein the multifunctional epoxy resin has a functionality of at least 3; and
wherein the liquid epoxy resin is different from the multifunctional epoxy resin;
ii) core-shell rubber particles,
wherein the cured reaction product of part A and part B has an initial Tg before exposure to coolant and a final Tg after exposure to coolant for 2 weeks, and
wherein the difference between the initial Tg and the final Tg is less than 30° C. under the Coolant Immersion Aging Test.

2. A two-part adhesive composition according to claim 1 further comprising an epoxy silane coupling agent in the epoxy part,
wherein the cured reaction product of part A and part B has an initial Overlap Shear Strength (OLS) before exposure to coolant and a final Overlap Shear Strength after exposure to coolant under the conditions of the Coolant Immersion Aging Test for 12 weeks, and
wherein the OLS after exposure to coolant is at least 70% of the initial OLS.

3. A two-part adhesive composition according to claim 1, wherein the curative part further comprises core-shell rubber particles.

4. A two-part adhesive composition according to claim 1, wherein the epoxy part further comprises silicone core-shell rubber particles.

5. A two-part adhesive composition according to claim 1, comprising the liquid bis-phenol compound in a range from 5% to 60% weight percent based on the total weight of the curative part.

6. A two-part adhesive composition according to claim 1, wherein the liquid bis-phenol compound is DABPA.

7. A two-part adhesive composition according to claim 1, wherein the curative part comprises a cycloaliphatic amine in a range from 10% to 90% weight percent based on the total weight of the curative part.

8. A two-part adhesive composition according to claim 1, wherein the cycloaliphatic amine is chosen from 4,4′-methylenebiscyclohexyl-amine or its alkyl substitutes.

9. A two-part adhesive composition according to claim 1, wherein the liquid epoxy resin in the epoxy part is in a range from 50% to 100% weight percent based on the total weight of the epoxy resin part.

10. A two-part adhesive composition according to claim 1, wherein the liquid epoxy resin is chosen from diglycidyl ethers of bisphenol F, low epoxy equivalent weight diglycidyl ethers of bisphenol A, liquid epoxy novolac resins, liquid aliphatic epoxy resins, liquid cycloaliphatic epoxy resins, 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, triglycidyls of para-aminophenol, N,N,N′,N′-tetraglycidyl-m-xylenediamine, and mixtures thereof.

11. A two-part adhesive composition according to claim 1, wherein the multifunctional epoxy resin is chosen from trifunctional glycidyl amine type epoxy resin (araldite MY 0510) trifunctional tris-(hydroxyl phenyl) methane-based epoxy resins (tactix 742), N,N,N′,N′-tetraglycidyl-4,4′-methylenebisbenzenamine (araldite MY 721)

12. A two-part adhesive composition according to claim 1, wherein the core-shell rubber particles have a core chosen from methyl methacrylate-butadiene-styrene (MBS) copolymers, methyl methacrylate-acrylonitrile-butadiene-styrene (MABS) copolymers, and combinations thereof.

13. A two-part adhesive composition according to claim 1, wherein the core-shell rubber particles have a shell chosen from acrylic polymers, acrylic copolymers, and combinations thereof.

14. A two-part adhesive composition according to claim 1, wherein the epoxy silane coupling agent is chosen from compounds represented by the formula 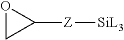
and wherein Z is a divalent organic group, and each L is independently a hydrolyzable group.

15. A cooling plate assembly comprising the cured reaction product of part A and part B described in claim 1.
